(19) United States
(12) Patent Application Publication
(10) Pub. No.: US 2010/0163375 A1
(43) Pub. Date: Jul. 1, 2010

(54) Switch

(76) Inventor: Michael P. Swift, Nottingham (GB)

Correspondence Address: DICKSTEIN SHAPIRO LLP, 1825 EYE STREET NW, Washington, DC, 20006-5403, US

(21) Appl. No.: 11/794,059

(22) PCT Filed: Dec. 23, 2005
(86) PCT No.: PCT/GB2005/005081

§ 371 Date: Apr. 22, 2008

(30) Foreign Application Priority Data
Dec. 24, 2004 (GB) 0428286.9

(51) Int. Cl. H01H 13/06

(52) U.S. Cl. 200/61.54; 200/302.2

(57) ABSTRACT

A switch comprising a first contact on a support surface, a switch housing sealingly secured to the support surface around the first contact to form a hermetically sealed chamber about the first contact, and a second contact movable in the chamber towards and away from the first contact, wherein the support surface is provided on a support having two or more protrusions protruding from the support surface and received in apertures formed in the switch housing to locate the switch housing relative to the first contact.

The present invention relates to a switch and in particular to a switch for an actuation mechanism of a vehicular horn assembly.

The horn assembly in a vehicle is commonly operated by means of an actuation mechanism located in the centre of the steering wheel.

One such arrangement includes a switch formed of two superimposed electrically conducting membranes laid under the top cover of the steering wheel and on top of an airbag module (if present). A series of dielectric dots formed on one of the membranes acts to separate the membranes until a force is applied to the top cover of the steering wheel, which serves to push the uppermost membrane into contact with the lower membrane and thereby close the switch to operate the horn.

Another such arrangement includes a floating plate switch, which is generally located under an airbag module in the centre of the steering wheel. In this arrangement a depressible plate is mounted on springs arranged to bias the plate away from the steering wheel. The plate includes a series of electrical contacts arranged to meet corresponding electrical contacts mounted on the steering wheel when the plate is depressed to operate the horn.

The first of these two arrangements forms a non-tactile mechanism in the sense that there is no discernible movement of the airbag module or any other portion of the steering wheel during operation of the horn. In contrast, the second of the two arrangements forms a tactile mechanism in the sense that it requires a discernible movement of the airbag module in order to operate the horn. It has been found that discernible movement is desirable with some vehicle drivers and undesirable with other vehicle drivers.

The electrical contacts used in combination with the floating plate of the second of the abovementioned arrangements are generally provided in the form of fixed moving conductors.

There is a need to reduce the cost and power consumption of actuation mechanisms.

For example, the use of fixed moving conductors relies on the provision of two layers of circuitry, which is not cost effective.

The use of fixed moving conductors also leads to the creation of a relatively high resistance at each switch therefore requiring a relatively high operating voltage and current. This is becoming increasingly problematical with the increase in the use of bus systems in vehicles, which operate at much lower voltages and currents.

One solution to reduce the resistance at each switch is to replace the fixed moving conductors with membrane switches. Each membrane switch includes a first membrane fixed in position and a second membrane movable towards and away from the first membrane. The movable membrane is generally mounted on a relatively small plunger. The pressure created when the plunger is pressed downwards to bring the second membrane into contact with the first membrane can lead to permanent deformation of one or both of the membranes, particularly if one or both of the membranes includes a dielectric dot pattern, and particularly in circumstances where a vehicle driver applies a relatively large force to the centre of the steering wheel in order to operate the horn.

To combat this effect, an elastomer pad may be placed between each plunger and the corresponding membrane to spread the load applied by the plunger. While the provision of elastomer pads provides a damping effect, there is a need to provide a switch that can withstand high actuation forces such as, for example, 490N.

The increasingly stringent testing that actuation mechanisms must undergo also means that there is a need for a switch that can withstand exposure to moisture and other contaminants such as salt.

According to a first aspect of the invention there is provided a switch comprising a first contact on a support surface a switch housing sealingly secured to the support surface around the first contact to form a hermetically sealed chamber about the first contact, and a second contact movable in the chamber towards and away from the first contact, wherein the support surface is provided on a support having two or more protrusions protruding from the support surface and received in apertures formed in the switch housing to locate the switch housing relative to the first contact.

Preferred and advantageous features of the first aspect of the invention are set out in dependent claims 2 to 12.

According to a second aspect of the present invention there is provided an actuation mechanism for a vehicular horn assembly comprising a printed circuit including two or more switch points, each switch point formed from the first contact of a switch according to the first aspect of the present invention such that that the circuit is closed on movement of the second contact in to contact with the first contact.

Preferably, the actuation mechanism is a laminated structure defining two power rails for attachment to a horn, the laminate being removed at each switch point in the circuit to expose the switch point.

According to a third aspect of the present invention there is provided a steering wheel assembly for a vehicle comprising a steering wheel; and actuation mechanism according to the second aspect of the present invention mounted on the steering wheel for connection to a horn; and a depressible actuation member mounted on the steering wheel by means of a resilient biasing means to bias the actuation member away from the steering wheel such that on depression of the actuation member towards the steering wheel, the actuation member causes contact between the first and second contacts of one or more of the switches of the actuation mechanism to operate the horn.

Embodiments of the invention will now be described, by way of non-limiting examples, with reference to the accompanying drawings in which:

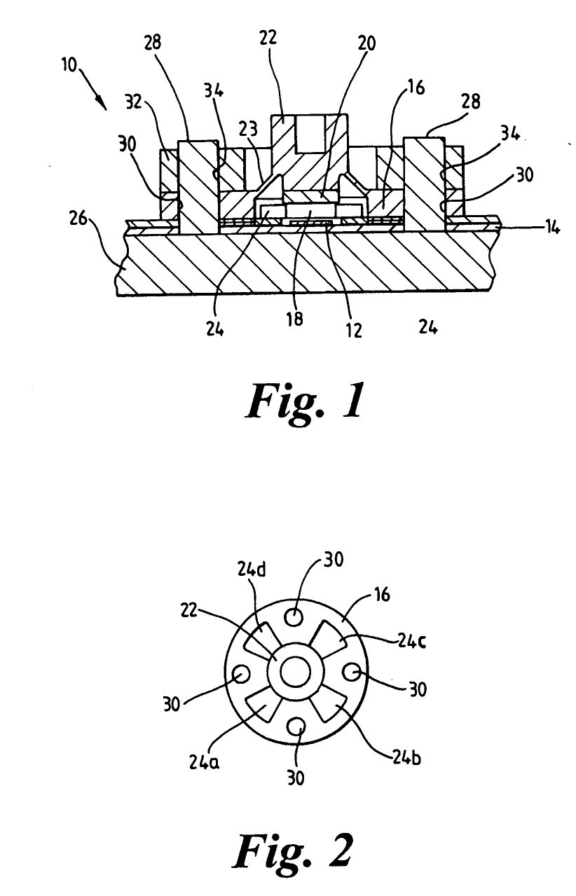

FIG. 1 shows a switch according to a first embodiment of the invention in cross-section;

FIG. 2 shows the switch housing of the switch of FIG. 1 in plan view;

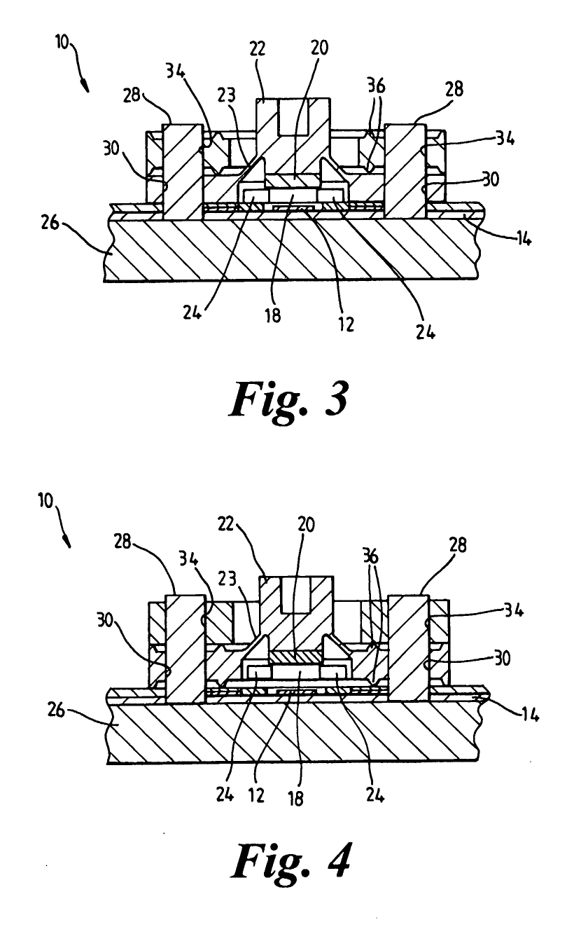

FIG. 3 shows a switch according to a second embodiment of the invention in cross-section;

FIG. 4 shouts a switch according to a third embodiment of the invention in cross-section;

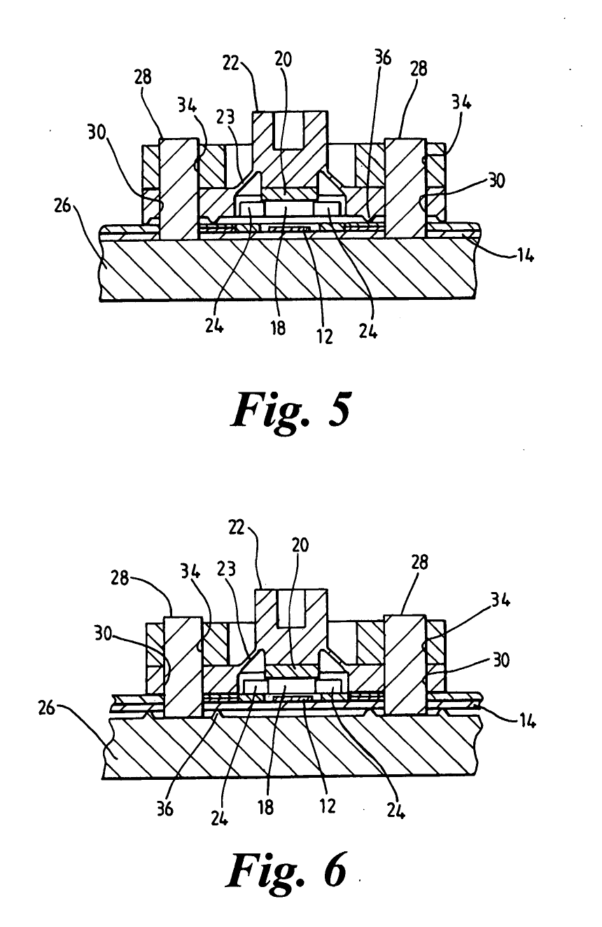

FIG. 5 shouts a switch according to a fourth embodiment of the invention in cross-section; and

FIG. 6 shows a switch according to a fifth embodiment of the invention in cross-section.

A switch 10 according to an embodiment of the invention is shown in FIG. 1.

The switch 10 includes a first contact 12 on a support surface 14, and a switch housing 16 sealingly secured to the support surface 14 around the first contact 12 to form a hermetically sealed chamber 18 about the first contact 12.

A second contact 20 is movable in the chamber 18 towards and away from the first contact 12 in order to close and open the switch 10 respectively.

The provision of a switch housing 16 sealingly secured to the support surface 14 in order to form a hermetically sealed chamber 18 about the first contact 12 ensures that the contacts 12, 20 are sealed against the ingress of contaminants.

The second contact 20 is preferably in the form of a conductive pill and may be formed of carbon for medium current applications or silver or gold for lower current applications (e.g. ˜3 mA). It is also envisaged that the second contact 20 could be formed from other conductive surfaces.

The second contact 20 is preferably mounted on an actuator 22 resiliently biased away from the first contact 12 and depressible from the exterior of the switch housing 16 to move the second contact 20 towards the first contact 12.

The provision of the actuator 22 provides an effective means for facilitating movement of the second contact 20 within the chamber 18.

The switch housing 16 is preferably formed from a resiliently deformable material. In such embodiments, the actuator 22 is preferably formed integrally with the switch housing 16.

In the embodiment shown in FIG. 1, the actuator 22 is connected via a deflectable collar 23 to the circumference of an aperture formed in the body of the switch housing 16 such that on the application of a downward force to the actuator 22 the collar 23 collapses and allows downward movement of the actuator 22, through the aperture, and further into the chamber 18 defined by the switch housing 16.

Forming the actuator 22 integrally with the switch housing 16 allows the actuator 22 to protrude from the switch housing 16 whilst ensuring that the chamber 18 can be sealed against the ingress of contaminants without the need for a separate seal between the actuator 22 and the switch housing 16.

The deformable material may be a rubber, an elastomer or other resilient material and is preferably a silicon elastomer, which can be molded to form the switch housing 16.

To ensure that the switch housing 16 is not unseated from the support surface 14 on depression of the actuator 22 into the chamber 18, the switch housing 16 is preferably shaped to define one or more internal reservoirs 24 in fluid communication with the chamber 18 to accommodate air compression on depression of the actuator 22 into the chamber 18.

In the embodiment shown in FIG. 1, the switch housing 16 is shaped to define four internal reservoirs 24a-24d (FIG. 2) equidistantly spaced about the circumference of the chamber 18.

In other embodiments it is envisaged that the number and relative position of such reservoirs may be varied.

The support surface 14 is preferably mounted on a support 26, which may include two or more protrusions 28 protruding through the support surface 14 and received in apertures 30 formed in the switch housing 16 to locate the switch housing 16 relative to the first contact 12.

An outer member 32 is preferably mounted on the switch housing 14 to compress the switch housing 14 between the support 26 and the outer member 32 and thereby sealingly secure the switch housing 16 to the support surface 14.

In the embodiment shown in FIG. 1, the outer member 32 is mounted on the protrusions 28 received in corresponding apertures 34 formed in the outer member 32.

The outer member 32 is preferably secured to the protrusions 28 in order to maintain the switch housing 16 under compression between the outer member 32 and the support 26.

The outer member 32 may be secured to the protrusions 28 by means of swaging, hot staking, gluing, welding or by means of a snap-fit engagement member provided on each protrusion and adapted to engage the upper surface of the outer member 32 and thereby prevent it being removed from the protrusions 28.

Preferably, the outer member 32 is secured in position such that the switch housing 16 is compressed between the outer member 32 and the support 26.

It is envisaged that in other embodiments the outer member 32 may be omitted, and the switch housing 16 may be sealingly secured to the support surface 14 by means of adhesive between the switch housing 14 and the support surface 14, and/or by securing the switch housing 14 to protrusions 28 by means of any of the methods referred above.

In the embodiment shown in FIG. 1, the switch housing 16 is formed as a circular member, the actuator 22 protruding centrally from the upper surface thereof, and the outer member 32 is formed as an annular member such that the actuator 22 protrudes through the central aperture provided in the outer member 32.

It is of course envisaged that the geometric shape of the switch housing 16 may vary in other embodiments. For example, the switch housing 16 may be formed to define a square-shaped or other geometrically shaped base for contact with the support surface 14.

It is also envisaged that the shape of the outer member 32 may change, depending on the shape of the switch housing 16 and the relative position of the actuator 22.

The outer member 32 in this arrangement advantageously provides a physical stop to limit depression of the actuator 22, and thereby prevent excessive pressure being applied to the contacts 12, 20. The outer member 32 therefore provides an effective means for ensuring that the switch is able to withstand large forces without damaging the actuator 22 or the contacts 12, 20.

The outer member 32 may, for example, be formed as a molding, casting or a pressing.

In use, an external force (such as, for example, from the floating plate of an actuation mechanism of a vehicular horn assembly) is applied to the actuator 22 of the switch 10, depressing the actuator 22 into the chamber 18 defined by the switch housing 16 and moving the second contact 20 mounted on the actuator 22 into contact with the first contact 12 provided on the support surface 14.

Downward movement of the actuator 20 compresses air present within the chamber 18, which in turn increases the air pressure within the chamber 18. This increased air pressure, tending to urge the switch housing 16 away from the support surface 14 as the compressed air attempts to escape to reduce the air pressure within the chamber 18, is distributed across the internal reservoirs 24 in fluid communication with the chamber 18. The air pressure is thereby distributed over a relatively large surface area and reduces the effect of the pressure increase such that the switch housing 16 remains in sealing contact with the support surface 14.

On removal of the downward force on the actuator 22, the resilient nature of the material from which the switch housing 16 is formed forces the actuator 22 to resume its starting position and move the second contact 20 out of contact with the first contact 12.

During use, the provision of the outer member 32 limits downward movement of the actuator 22. It therefore limits the size of the force that may be transferred to the actuator 22 and the contacts 12, 20, thereby protecting them from the application of excessive forces, which only serve to push the outer member 32 against the switch housing 16 and thereby assist in maintaining the sealing contact between the switch housing 16 and the support surface 14.

In other embodiments, projections 36 may be formed on one or both of the surfaces of the support 26, switch housing 16 and/or the outer member 32 in order to assist maintenance of the seal between the switch housing 16 and the support surface 14.

For example, in the embodiment shown in FIG. 3, projections 36 are formed on the face of the upper member 32 in contact with the upper surface of the switch housing 16. The provision of these projections assists in the application of pressure to the switch housing 16 in order to maintain the seal between the switch housing 16 and the support surface 14.

As shown in FIG. 3, projections 36 are preferably formed on both faces of the upper member 32 to ensure that the upper member 32 is not directional and can be assembled in either orientation, thereby easing assembled of the switch 10.

In the embodiment shown in FIG. 4, projections 36 are formed on the upper and lower contact surfaces of the switch housing 16 to assist the application of pressure between the switch housing 16 and the outer member 32 and support surface 14 respectively.

In other embodiments, projections 36 may be formed on only the upper or lower contact surfaces of the switch housing 16, as shown in FIG. 5, where projections are provided on the lower surface of the switch housing 16 to assist the creating of a hermetic seal between the switch housing 16 and the support surface 14.

In the embodiment shown in FIG. 6, projections 36 are provided on the upper surface of the support 26 to press against the support surface 14 and assist in maintaining the support surface 14 in sealing contact with the switch housing 16.

In each of the embodiments referred to above, the support surface 14 may be in the form of a circuit provided on a substrate by additive or subtractive methods such as, for example, screen printing, etching or other printing methods. Any such circuit preferably includes an insulation layer, such as, for example, a laminate layer, to protect the circuit from the ingress of contaminants. The first contact 12 may be formed by removing a portion of the insulation layer oil one side to expose an area of the printed circuit.

For use in an actuation mechanism for a vehicle horn assembly, the circuit preferably defines two tracks having one or more switch points where the tracks may be connected to complete the circuit. The insulation layer is preferably removed, at the or each switch point, to define a first contact 12 for a switch 10.

The use of a circuit defining two tracks removes the need to use two layers of circuitry, and thereby provides an effective means for reducing the cost of producing an actuation mechanism for a vehicular horn assembly.

The use of the circuit in combination with a moving contact also reduces the resistance at each switching point, thereby reducing the required operating voltage and current and rendering the arrangement suitable for use with a bus system.

In use, the insulated circuit having a switch 10 according to the invention at each switch point may be mounted on a fixed plate on the central portion of a steering wheel.

A floating plate may then be aligned with the fixed plate and the switches 10, and mounted on resilient biasing means, such as, for example, springs, on the central portion of the steering wheel so as to be biased away from the steering wheel. The airbag module of the steering wheel may then be mounted on the floating plate.

The resilient bias between the floating plate and the central portion of the steering wheel permits depression of the floating plate so as to contact one or more of the switches 10 provided around the printed circuit. This in turn causes contact between the first and second contacts 12,20 of the switch 10 and creates a short circuit across the corresponding switch point, thereby closing the switch and completing a circuit to facilitate operation of a horn connected to the circuit.

In other arrangements, the insulated circuit may be mounted on the floating plate instead of the fixed plate. In such arrangements, depression of the floating plate towards the fixed plate brings the fixed plate into contact with one or more of the switches 10 provided around the printed circuit. This in turn causes contact between the first and second contacts 12,20 of the switch 10 and creates a short circuit across the corresponding switch point, thereby closing the switch and completing a circuit to facilitate operation of a horn connected to the circuit.

1. A switch comprising a first contact on a support surface, a switch housing sealingly secured to the support surface around the first contact to form a hermetically sealed chamber about the first contact, and a second contact movable in the chamber towards and away from the first contact, wherein the support surface is provided on a support having two or more protrusions protruding from the support surface and received in apertures formed in the switch housing to locate the switch housing relative to the first contact.

2. A switch according to claim 1 wherein the second contact is mounted on an actuator resiliently biased away from the first contact and depressible from the exterior of the switch housing to move the second contact towards the first contact.

3. A switch according to claim 2 wherein the switch housing is formed from an elastically deformable material and the actuator is formed integrally with the switch housing.

4. A switch according to claim 3 wherein the deformable material is an elastomer.

5. A switch according to claim 4 wherein the elastomer is silicon.

6. A switch according to claim 2 wherein the switch housing defines one or more internal reservoirs to accommodate air compression within the chamber on depression of the actuator.

7. A switch according to claim 1 further including an outer member mounted on the protrusions to compress the switch housing between the outer member and the support and sealingly secure the switch housing to the support surface.

8. A switch according to claim 1 wherein the switch housing and/or an outer member is secured to the protrusions.

9. A switch as claimed in claim 8 wherein the switch housing and/or the outer member is secured to the protrusions by means of swaging, hot staking, gluing, welding or a snap-fit engagement member provided on each protrusion.

10. A switch according to claim 7, wherein the second contact is mounted on an actuator resiliently biased away from the first contact and depressible from the exterior of the switch housing to move the second contact towards the first contact, and wherein the actuator protrudes through an aperture formed in the outer member such that the outer member defines a stop to limit depression of the actuator.

11. A switch according to claim 1 wherein adhesive is provided between the switch housing and the support surface to sealingly secure the switch housing to the support surface.

12. A switch according to claim 1 wherein the first contact is a switch point in a printed circuit and contact between the first and second contacts closes the circuit.

13. An actuation mechanism for a vehicular horn assembly comprising a printed circuit including two or more switch points, each switch point forming a first contact of a switch such that the circuit is closed on movement of a second contact into contact with the first contact, wherein the switch comprises:
the first contact on a support surface:
a switch housing sealingly secured to the support surface around the first contact to form a hermetically sealed chamber about the first contact; and
the second contact that is movable in the chamber towards and away from the first contact,
wherein the support surface is provided on a support having two or more protrusions protruding, from the support surface and received in apertures formed in the switch housing to locate the switch housing relative to the first contact.

14. An actuation mechanism according to claim 13 wherein the printed circuit is a laminated structure defining two power rails for attachment to a horn, the laminate being removed at each switch point in the circuit to expose the switch point.

15. A steering wheel assembly for a vehicle comprising.
a steering wheel;
an actuation mechanism mounted on the steering wheel for connecting to a horn; and
a depressible actuation member mounted on the steering wheel by means of a resilient biasing means to bias the actuation member away from the steering wheel such that on depression of the actuation member, towards the steering wheel, the actuation member causes contact between a first contact and a second contact of one or more switches of the actuation mechanism to operate the horn.
wherein the actuation mechanism comprises a printed circuit including two or more switch points, each switch point forming the first contact of a switch such that the circuit is closed on movement of the second contact into contact with the first contact, wherein each switch comprises:
the first contact on a support surface;
a switch housing sealingly secured to the support surface around the first contact to form a hermetically sealed chamber about the first contact; and
the second contact that is movable in the chamber towards and away from the first contact.
wherein the support surface is provided on a support having two or more protrusions protruding from the support surface and received in apertures formed in the switch housing to locate the switch housing relative to the first contact.

16. A switch according to claim 8 wherein the second contact is mounted on an actuator resiliently biased away from the first contact and depressible from the exterior of the switch housing to move the second contact towards the first contact, and wherein the actuator protrudes through an aperture formed in the outer member such that the outer member defines a stop to limit depression of the actuator.
